(19) United States
(12) Patent Application Publication
(10) Pub. No.: US 2015/0241734 A1
(43) Pub. Date: Aug. 27, 2015

(54) SEE-THROUGH LIQUID-CRYSTAL DISPLAY

(71) Applicant: LITEMAX ELECTRONICS INC., NEW TAIPEI CITY (TW)

(72) Inventor: JUNG-CHI LO, NEW TAIPEI CITY (TW)

(73) Assignee: LITEMAX ELECTRONICS INC., NEW TAIPEI CITY (TW)

(21) Appl. No.: 14/191,514

(22) Filed: Feb. 27, 2014

(51) Int. Cl. G02F 1/1335; G09F 13/00

(52) U.S. Cl. CPC G02F 1/133528; G09F 13/005

(57) ABSTRACT

A see-through liquid-crystal display disposed in front of an object includes a hollow-cored frame; a liquid crystal panel disposed at an inside of the hollow-cored frame and having a first surface and an opposing second surface; a first polarizing film adhered to the first surface of the liquid crystal panel and having at least a first hollow region corresponding in position to the object; a second polarizing film adhered to the second surface of the liquid crystal panel; a backlight unit electrically connected to the liquid crystal panel; a control unit electrically connected to the liquid crystal panel; a power unit electrically connected to the backlight unit and the control unit, wherein the backlight unit, the control unit, and the power unit do not hide the at least a first hollow region. Onlookers can look at the see-through liquid-crystal display and the object behind the see-through liquid-crystal display simultaneously.

### FIELD OF TECHNOLOGY

The present invention relates to liquid-crystal display, and more particularly, to a see-through liquid-crystal display which allows a person to look simultaneously at it and goods displayed in a showcase on which the see-through liquid-crystal display is mounted.

### BACKGROUND

A liquid-crystal display is usually mounted on a show case which contains goods for sale or on display. The liquid-crystal display presents to customers a description of the goods. The liquid-crystal display is separate from the goods by a distance, and thus the customers cannot look at the goods and the displayed description thereof simultaneously.

Slot machines in casinos and the like come in two categories, namely mechanical gambling machines with physical reels that spin and stop to reveal one or several symbols displayed on the physical reels, and electronic gambling machines with a liquid-crystal display for displaying simulated reels that spin and stop to reveal one or several symbols displayed on the simulated reels. The mechanical gambling machines are insusceptible to cheating but are monotonous in appearance and ineffective in generating sound and light, thereby not appealing to regular gamblers. On the contrary, electronic gambling machines are susceptible to cheating but effective in generating sound and light, thereby appealing to gamblers. Hence, both the mechanical gambling machines and the electronic gambling machines have their own advantages and disadvantage.

Accordingly, it is imperative to provide a liquid-crystal display mounted on a showcase which contains goods for sale or on display, such that customers can look at the liquid-crystal display and the goods simultaneously.

### SUMMARY

It is an objective of the present invention to provide a see-through liquid-crystal display whereby customers can look simultaneously at the see-through liquid-crystal display and an object positioned behind the see-through liquid-crystal display.

In order to achieve the above and other objectives, the present invention provides a see-through liquid-crystal display disposed at a front of an object. The see-through liquid-crystal display comprises: a hollow-cored frame; a liquid crystal panel disposed at an inside of the hollow-cored frame and having a first surface and an opposing second surface; a first polarizing film adhered to the first surface of the liquid crystal panel and having at least a first hollow region corresponding in position to the object; a second polarizing film adhered to the second surface of the liquid crystal panel; a backlight unit electrically connected to the liquid crystal panel; a control unit electrically connected to the liquid crystal panel; and a power unit electrically connected to the backlight unit and the control unit, wherein the backlight unit, the control unit, and the power unit do not hide the at least a first hollow region.

As regards the see-through liquid-crystal display, the at least a first hollow region is rectangular, round, elliptical or of any other geometrical shape.

As regards the see-through liquid-crystal display, the first hollow regions are in the number of two.

As regards the see-through liquid-crystal display, the second polarizing film has at least a second hollow region corresponding in position to the at least a first hollow region, respectively, wherein the backlight unit, the control unit, and the power unit do not hide the at least a second hollow region.

In conclusion, the present invention provides a see-through liquid-crystal display which allows a person to look simultaneously at it and an object behind the see-through liquid-crystal display.

### BRIEF DESCRIPTION

Objectives, features, and advantages of the present invention are hereunder illustrated with specific embodiments in conjunction with the accompanying drawings, in which:

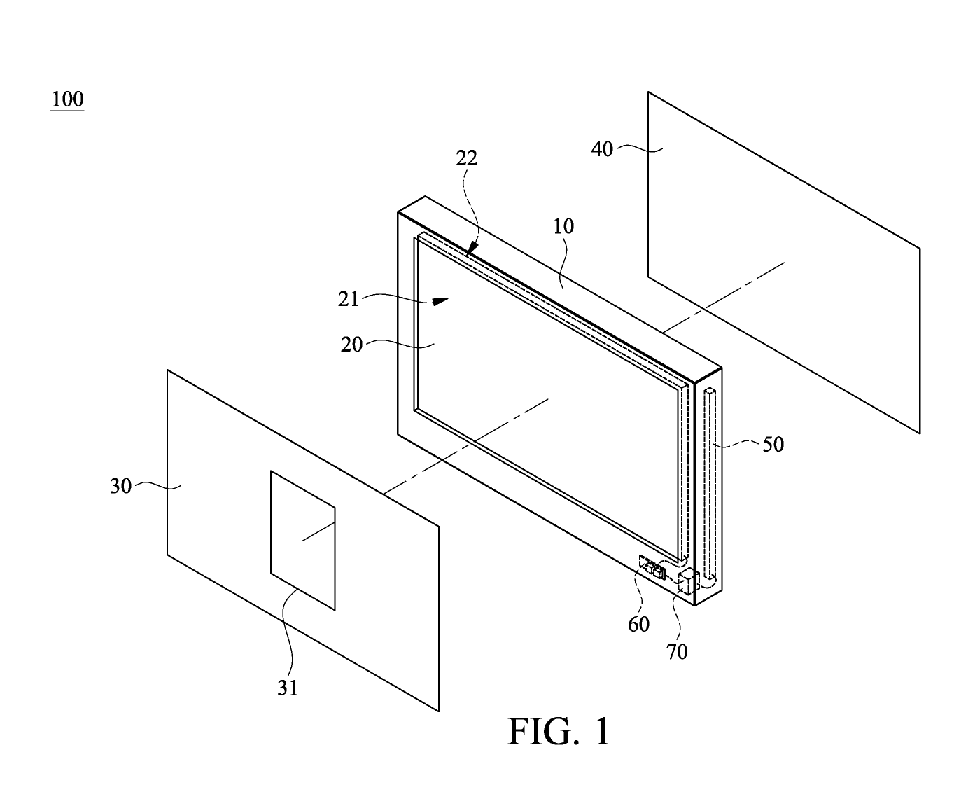

FIG. 1 is a schematic view of a see-through liquid-crystal display according to the first embodiment of the present invention;

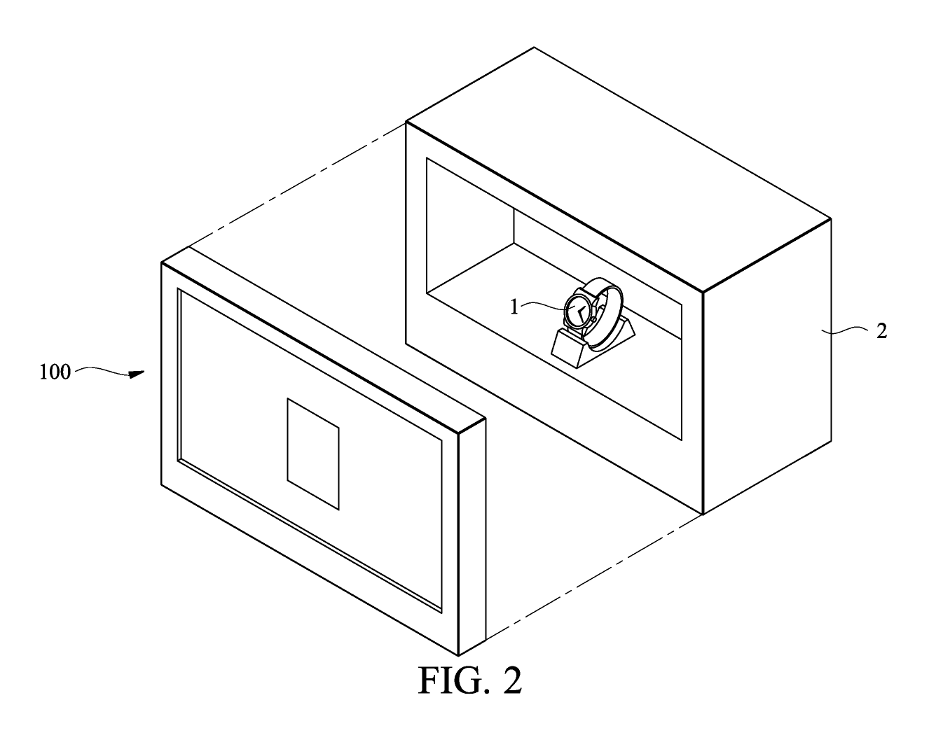

FIG. 2 is a perspective view of the see-through liquid-crystal display and a showcase according to the first embodiment of the present invention;

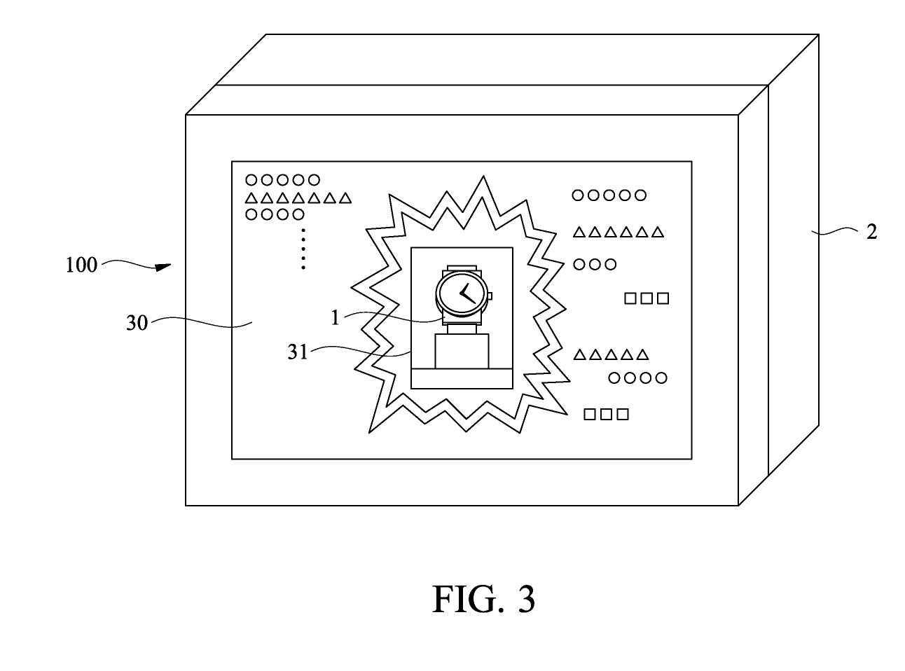

FIG. 3 is a schematic perspective view of the showcase and the see-through liquid-crystal display mounted on the showcase according to the first embodiment of the present invention;

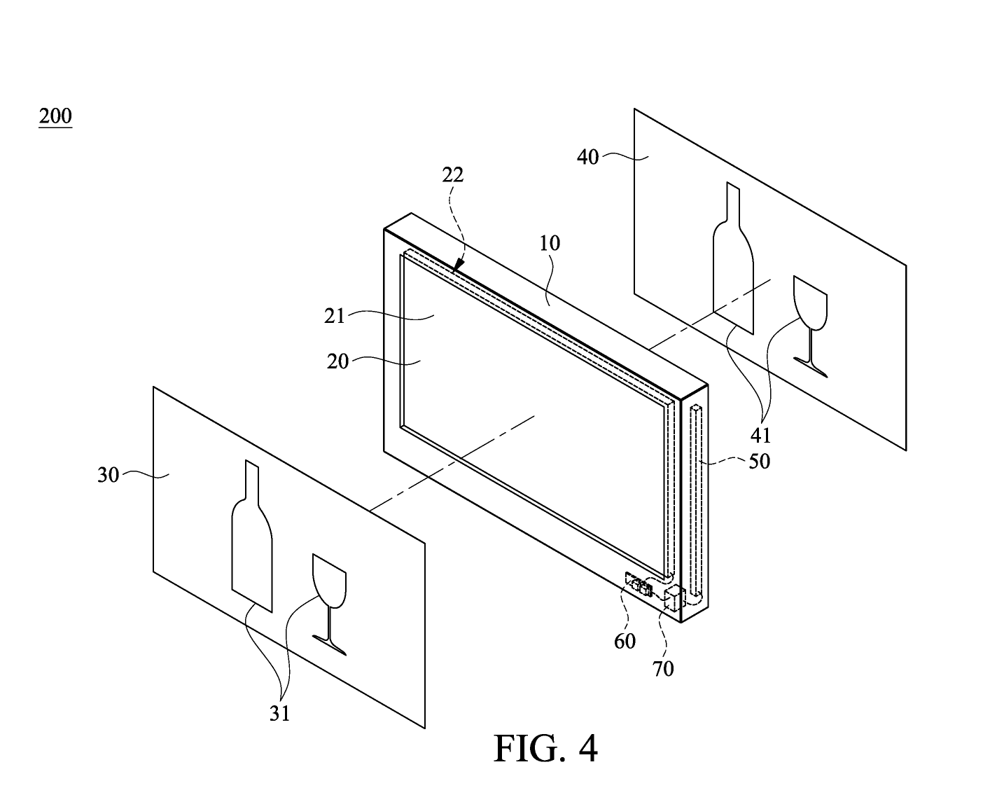

FIG. 4 is a schematic view of a see-through liquid-crystal display according to the second embodiment of the present invention; and

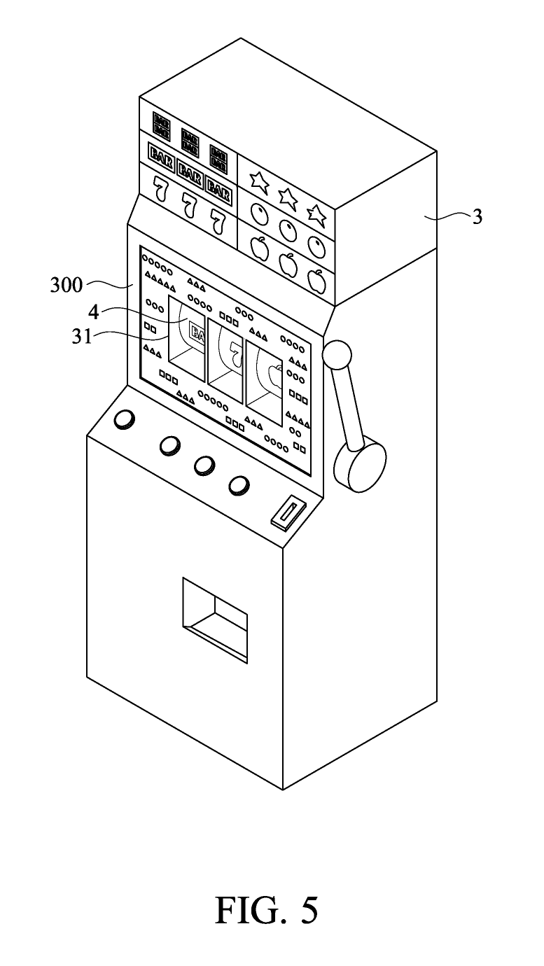

FIG. 5 is a perspective view of a gambling machine and a see-through liquid-crystal display mounted on the gambling machine according to the third embodiment of the present invention.

### DETAILED DESCRIPTION

Referring to FIG. 1 through FIG. 3, a see-through liquid-crystal display 100 is provided according to the first embodiment of the present invention. The see-through liquid-crystal display 100 is disposed at a front of an object 1. The see-through liquid-crystal display 100 comprises a hollow-cored frame 10, a liquid crystal panel 20, a first polarizing film 30, a second polarizing film 40, a backlight unit 50, a control unit 60, and a power unit 70.

The liquid crystal panel 20 is disposed at the inside of the hollow-cored frame 10. The liquid crystal panel 20 has a first surface 21 and an opposing second surface 22. The first polarizing film 30 is adhered to the first surface 21 of the liquid crystal panel 20. The first polarizing film 30 has at least a first hollow region 31. The at least a first hollow region 31 is rectangular, round, elliptical or of any other geometrical shape, for example, with the outline of a watch, a cup, a flask, or any object. The second polarizing film 40 is adhered to the second surface 22 of the liquid crystal panel 20. The backlight unit 50 is electrically connected to the liquid crystal panel 20 and adapted to serve as a light source for the liquid crystal panel 20. The control unit 60 is electrically connected to the liquid crystal panel 20 and adapted to control the operation of the liquid crystal panel 20. The power unit 70 is electrically connected to the backlight unit 50 and the control unit 60 and adapted to supply power to the backlight unit 50 and the control unit 60. The backlight unit 50, the control unit 60, and the power unit 70 do not hide the at least a first hollow region 31.

Referring to FIG. 2, a user puts the see-through liquid-crystal display 100 at a front of a showcase 2. Specifically speaking, the see-through liquid-crystal display 100 is disposed in front of the object 1.

Referring to FIG. 3, the at least a first hollow region 31 of the see-through liquid-crystal display 100 corresponds in position to the object 1. Hence, when the see-through liquid-crystal display 100 is disposed in front of the showcase 2, onlookers can look simultaneously at the at least a first hollow region 31 of the see-through liquid-crystal display 100 and the object 1 behind the see-through liquid-crystal display 100.

Referring to FIG. 3, at this point in time, the see-through liquid-crystal display 100 displays a description of the object 1. For instance, if the object 1 is a watch, the see-through liquid-crystal display 100 will have lines or patterns disposed at the periphery of the at least a first hollow region 31 to highlight the presence of the object 1. Furthermore, the see-through liquid-crystal display 100 displays the particulars of the object 1, such as price, manufacturing method, place of origin, and brand. Understandably, the contents displayed on the see-through liquid-crystal display 100 are not restricted to the above-mentioned; instead, the see-through liquid-crystal display 100 can also display any data which persons skilled in the art are familiar with.

In conclusion, according to the first embodiment of the present invention, a see-through liquid-crystal display has at least a first hollow region whereby onlookers can look simultaneously at an object disposed in a showcase and related data displayed on the see-through liquid-crystal display.

Referring to FIG. 4, a see-through liquid-crystal display 200 is provided according to the second embodiment of the present invention. The see-through liquid-crystal display 200 is substantially identical to the see-through liquid-crystal display 100 in terms of constituent elements, except that the second polarizing film 40 of the see-through liquid-crystal display 200 has at least a second hollow region 41 corresponding in position to the at least a first hollow region 31, wherein the backlight unit 50, the control unit 60, and the power unit 70 do not hide the at least a second hollow region 41. Hence, the object (not shown) behind the see-through liquid-crystal display 200 is visible to onlookers present in front of the see-through liquid-crystal display 200.

Referring to FIG. 4, understandably, the shape of the at least a first hollow region 31 and the shape of the at least a second hollow region 41 are subject to changes as needed. For example, if the object is a wine bottle or a cup, the first hollow regions 31 are in the number of two, whereas the second hollow regions 41 are also in the number of two, wherein the shape of the first hollow regions 31 and the shape of the second hollow regions 41 have the outline of the wine bottle or the cup.

As indicated above, the quantity, shape, and size of the first hollow regions 31 and the second hollow regions 41 are subject to changes as needed.

Referring to FIG. 5, a see-through liquid-crystal display 300 is provided according to the third embodiment of the present invention. The see-through liquid-crystal display 300 is substantially identical to the see-through liquid-crystal display 200 in terms of constituent elements, except that the first hollow regions 31 of the see-through liquid-crystal display 300 are in the number of three, whereas the second hollow regions (not shown) of the see-through liquid-crystal display 300 are also in the number of three. As shown in FIG. 5, the first hollow regions 31 correspond in position to a plurality of physical reels 4 of a mechanical gambling machine 3, respectively.

Once the user mounts the see-through liquid-crystal display 300 in the front of the physical reels 4, the see-through liquid-crystal display 300 will be capable of manifesting various visual effects to thereby operate in conjunction with the physical reels 4 and thus enhance the visual perception of onlookers, such that the onlookers perceive various visual effects manifested by the see-through liquid-crystal display 300 while looking at the physical reels 4.

In conclusion, according to the embodiments of the present invention, a see-through liquid-crystal display is defined with at least a first hollow region and at least a second hollow region. Due to the at least a first hollow region, onlookers can look at the see-through liquid-crystal display and an object behind the see-through liquid-crystal display simultaneously. Due to the at least a second hollow region, the onlookers can see the object clearly.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A see-through liquid-crystal display disposed at a front of an object, the liquid-crystal display comprising:
a hollow-cored frame;
a liquid crystal panel disposed at an inside of the hollow-cored frame and having a first surface and an opposing second surface;
a first polarizing film adhered to the first surface of the liquid crystal panel and having at least a first hollow region corresponding in position to the object;
a second polarizing film adhered to the second surface of the liquid crystal panel;
a backlight unit electrically connected to the liquid crystal panel;
a control unit electrically connected to the liquid crystal panel; and
a power unit electrically connected to the backlight unit and the control unit, wherein the backlight unit, the control unit, and the power unit do not hide the at least a first hollow region.

2. The see-through liquid-crystal display of claim 1, wherein the at least a first hollow region is rectangular, round, elliptical or of any other geometrical shape.

3. The see-through liquid-crystal display of claim 2, wherein the first hollow regions are in the number of two.

4. The see-through liquid-crystal display of claim 1, wherein the first hollow regions are in the number of two.

5. The see-through liquid-crystal display of claim 1, wherein the second polarizing film has at least a second hollow region corresponding in position to the at least a first hollow region, respectively, wherein the backlight unit, the control unit, and the power unit do not hide the at least a second hollow region.

6. The see-through liquid-crystal display of claim 2, wherein the second polarizing film has at least a second hollow region corresponding in position to the at least a first hollow region, respectively, wherein the backlight unit, the control unit, and the power unit do not hide the at least a second hollow region.

7. The see-through liquid-crystal display of claim 3, wherein the second polarizing film has at least a second hollow region corresponding in position to the at least a first hollow region, respectively, wherein the backlight unit, the control unit, and the power unit do not hide the at least a second hollow region.

8. The see-through liquid-crystal display of claim 4, wherein the second polarizing film has at least a second hollow region corresponding in position to the at least a first hollow region, respectively, wherein the backlight unit, the control unit, and the power unit do not hide the at least a second hollow region.
